(19) United States
(12) Patent Application Publication
(10) Pub. No.: US 2005/0244014 A1
(43) Pub. Date: Nov. 3, 2005

(54) Acoustic-based temperature sensing in telephones

(75) Inventors: Gary W. Elko, Summit, NJ (US); Eric J. Diethorn, Long Valley, NJ (US); Valentine C. Matula, Granville, OH (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology Corp.

(21) Appl. No.: 10/835,783

(22) Filed: Apr. 30, 2004

(51) Int. Cl. H04R 29/00

(52) U.S. Cl. 381/58; 381/59; 381/95

(57) ABSTRACT

A communication device includes a speaker, a microphone, and a processor connected to the speaker and the microphone. The processor is arranged for calculating ambient temperature by playing a test sound on the speaker, measuring a transit time of the test sound from the speaker to the microphone, and determining the ambient temperature from the measured transit time. A method of calculating ambient temperature by using a communications device having a speaker, a microphone and a processor is also disclosed. The method can be used for monitoring ambient temperatures of machinery and for detecting fire conditions.

### BACKGROUND OF THE INVENTION

1. Field of the Invention

The present invention relates to a communication device having temperature sensing capabilities.

2. Description of the Related Art

Communication devices such as mobile phones, Personal Digital Assistants (PDAs), and stationary phones typically do not have temperature sensing capabilities. Users of these communication devices will rely on external conventional temperature sensing devices such as thermometers and temperature probes to determine ambient temperatures. These conventional temperature sensing devices are installed in various locations for monitoring ambient temperatures and/or for monitoring temperatures indicative of a fire. Instead of relying on these fixed external temperature sensing devices, it is desirable in some cases for a user to determine the ambient temperature of an immediate area. Using conventional thermometers and/or temperature sensing devices to measure all immediate areas in which a user could be located would require the installation of many temperature sensing devices and is cost intensive, especially if many areas are to be measured.

If conventional temperature sensing devices such as thermometers and temperature probes are added to existing mobile communication devices to provide a temperature measurement function for measuring the temperature of the environment in which the communication device is located, an additional cost to the device is incurred. Furthermore, the thermometer or temperature probe must be arranged on the communication device so that user interaction with the device does not affect the temperature reading. Accordingly, the incorporation of a temperature measurement device may incur an additional design cost.

If centralized monitoring of temperature is desired, conventional temperature sensing devices must be connected to a separate communication network or a costly integration module must be added to the temperature sensors so that the temperature information detected by the temperature sensing devices may be communicated to a central monitoring area using existing communication networks.

### SUMMARY OF THE INVENTION

An object of the present invention is to provide temperature monitoring capabilities to a communication device without requiring the addition of a dedicated temperature sensor to the communication device.

A communication device according to the present invention includes a speaker, a microphone, and a processor operatively arranged for calculating ambient temperature by playing a test sound on the speaker, measuring a transit time of the test sound from the speaker to the microphone, and calculating the ambient temperature from the measured transit time.

A method according to the present invention for calculating ambient temperature of a communication device having a speaker and a microphone, includes the steps of playing a test sound on the speaker, measuring a transit time of the test sound from the speaker to the microphone, and calculating an ambient temperature based on the measured transit time.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic block diagram of a communication device according to the present invention;

FIG. 2 is a flow diagram showing steps for determining ambient temperature according to the present invention; and

FIG. 3 is a flow diagram showing further steps of the present invention.

### DETAILED DESCRIPTION OF THE PRESENTLY PREFERRED EMBODIMENTS

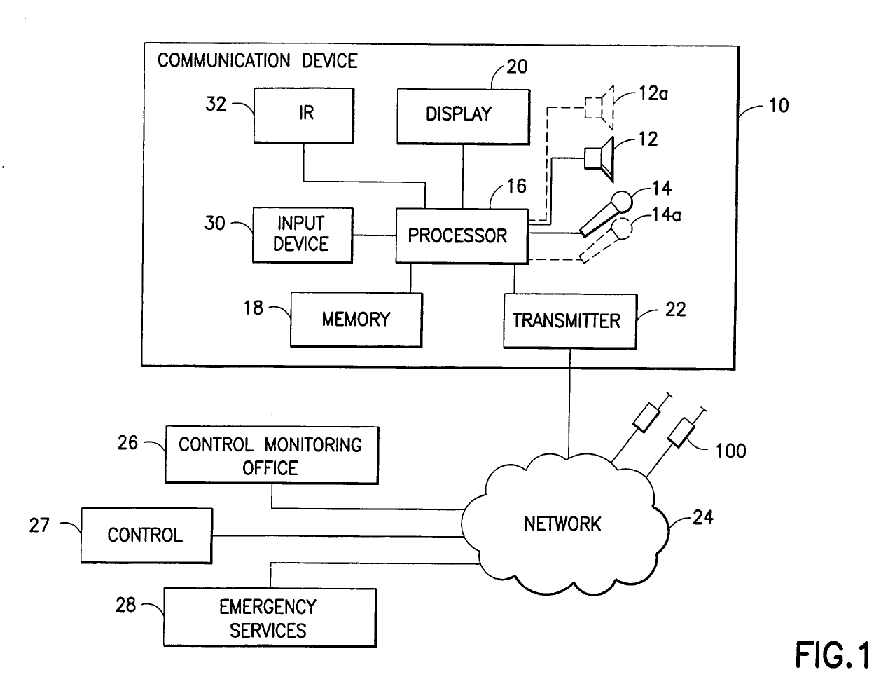

FIG. 1 shows a mobile communication device 10 including a speaker 12 and a microphone 14. The communication device 10 may comprise a wireless mobile phone for communicating with other communication devices 100 through a communication network 24. For this purpose, the communication device 10 includes a processor 16 for processing received communication signals into audio signals and for generating audio signals, and a transceiver 22 for sending and receiving communication signals. Instead of a wireless mobile phone, the communication device may comprise any mobile or stationary communication device having a speaker and a microphone such as a PDA, laptop or desktop computer. As will be described below in more detail, the speaker 12 and microphone 14 must be separated by at least a minimum distance from each other in the operating state of the device.

The communication device 10 also includes a display 20 for displaying information to a user of the communication device 10, a memory 18, and an input device 30 such as the numerical keyboard and/or other input keys on a typical mobile phone. The input keys may be hard wired to have specific functions such as the numerical keys on a keypad, or the input keys may be soft keys having different functions in different operating states of the communication device.

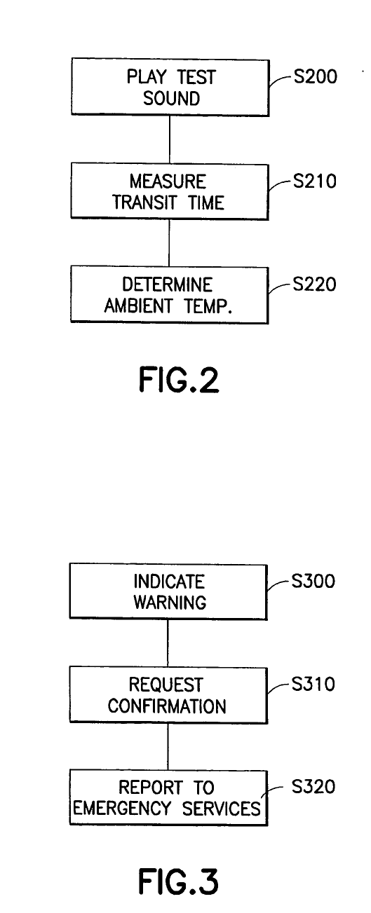

The communication device 10 includes the ability to determine ambient temperature using the method illustrated in the flow diagram of FIG. 2. According to the inventive method, a test signal is generated by processor 16 or retrieved from memory 18 and is played on the speaker 12, step S200. The transit time of the test sound from the speaker 12 until detection occurs at the microphone 14 is measured by the processor 16, step S210. The ambient temperature is then calculated by the processor based on the transit time of the test sound, S220. The calculated ambient temperature may then be displayed on the display 20.

The present invention relies on the principle that as air temperature varies, its density varies. The change in air density causes the speed of sound to vary according to the formula: v=331\sqrt{T/273°} m/sec., where T is the temperature in ° K. The time required for sound to travel a known distance varies as a function of the air temperature according to the formula

$$t = \frac{x}{v} ,$$

where x is the distance between the speaker and the microphone and v is the speed of sound. Accordingly, the velocity v, and thus the temperature T, may be calculated from the above formulas using the transit time measured in step S210 and the known distance. If two microphones located at different distances from the source of sound are used, each microphone will detect the sound at a different time based on the time required for the sound to travel to each microphone. As described below, the difference between the times of detection at the two microphones may be used to determine the velocity.

The speaker 12 may have an associated delay inherent in a transducer of the speaker 12. This delay may be mitigated in devices having more than one microphone such as, for example, desk phones having a handset with a first microphone 14 and first speaker 12 and a second microphone 14a and speaker 12a on the phone console for hand-free or “speaker-phone” operation. FIG. 1 shows the optional second microphone 14a and second speaker 12a in dotted lines. According to this embodiment, the test signal is played on one of the speakers 12, 12a in step S200. In step S210, the transit time of the test sound until detection at each of the microphones 14, 14a is measured by the processor 16. The velocity v and thus the temperature T may be solved by

$$( {t}_{2} - {t}_{1} ) = \frac{{χ}_{2} - {χ}_{1}}{v} , or v = \frac{{χ}_{2} - {χ}_{1}}{{t}_{2} - {t}_{1}} ,$$

wherein x₁ is the distance between the first microphone 14 and the speaker 12 or 12a, x₂ is the distance between the second microphone 14a and the speaker 12 or 12a, and t₂-t₁ is the difference in time between the time of reception of the test signal at the first and second microphones 14 and 14a. Instead of measuring the transit times from initiation of the test sound to reception at each microphone, the time between detection by each of the microphones may be measured in step S210. The time between detection by each microphone may be determined by direct measurement of the time between the detection occurrences. Alternatively, the time between detection may be determined based on a transfer function between the two microphones, i.e., based on phase versus frequency. Since the above calculation is based on the time difference between reception at each microphone, any static or variable time delay introduced by the speaker is avoided by this calculation.

The distance between the speaker 12 and microphone 14 (and/or microphone 14a) of the communication device 10 is a fixed quantity and may be saved into the memory 18. Alternatively, the distance between the speaker and microphone may be derived when a reference temperature is known. For deriving the distance between the speaker and the microphone, the speed of sound is known at a known temperature and the distance can be determined using the transit time of the test sound between the speaker and microphone.

The temperature calculation feature can be performed periodically by the processor, e.g., every five minutes, etc. Alternatively, the temperature can be calculated in response to a specific user command input by the user via the input device 30 of the communication device.

Once the temperature calculation is desired, it can be transmitted by the communication device to a recipient device system. For example, the temperature measurement can be communicated automatically by the communication device to one or more other devices in communication with the communication device 10. In the case of a communication device comprising a mobile phone, the temperature calculation by a first mobile phone (phone A) can be transmitted to a second mobile phone (phone B), either at the time a call is connected or upon selecting an appropriate function key on phone A.

Furthermore, some communication devices such as PDAs or mobile phones include infrared (IR) sensors 32 (see FIG. 1) for IR communications with other devices. The IR sensors may be monitored by the processor 16 for signals indicative of a fire. When a signal indicative of the fire is received, the processor 16 may initiate a determination of the ambient temperature using the above described method as a confirmation of a fire and may transmit the temperature calculation to fire fighting or fire detecting personnel. As described in more detail below, the communication device may include a location of the communication device in the transmission to fire fighting or fire detecting personnel.

As shown in FIG. 3, the method may provide a warning indication (audio and/or visual) if the ambient temperature exceeds a threshold, step S300. The threshold may indicate that the operating temperature exceeds a safe operating range of the communication device 10 or a safe operating range of other devices located in proximity to the communication device. The communication device 10 may additionally automatically transmit a warning signal to a central monitoring office 26 (see FIG. 1) through communication network 24. Furthermore, the communication device 10 may transmit a control signal to a control device 27 to counteract the out of range temperature condition. For example, the communication device 10 may be a computer having a speaker and microphone stationed in a room having manufacturing equipment which is required to operate within a desired temperature range. If the room temperature as calculated by the computer exceeds the upper or lower limits of the temperature range, the communication device visually or audibly indicates a warning so that an operator in the room is made aware of the problem. The communication device may additionally transmit a control signal through the network 24 to the control device 27, which may include a heating/cooling system or a supplemental heating/cooling system for the room to counter the out of range temperature condition. The network 24 may comprise a local area network (LAN) or a wide area network (WAN) and may be wired or wireless.

Instead of determining whether the ambient temperature is within an operating range, a threshold level may be set on the communication device 10 to indicate a possible fire condition. If the communication device 10 is a mobile device normally carried by the user, or is any device which is normally attended by a person, a request for a confirmation that there is an actual fire may be visually displayed or audibly transmitted to the user, step S310. Once the confirmation by the user is received, the communication device 10 may transmit a report to emergency services 28 through the network 24 (see FIG. 1), step S320. In addition, or alternatively, the communication device 10 may also monitor the rate of temperature change between successive determinations of the ambient temperature. In this case, a steep climb in the ambient temperature may be considered indicative of a fire and the steps S310, and S320 may be performed in response to the high rate of temperature change.

Service providers of wireless communications networks typically provide location services for their customers which determine a location of the customer's wireless device so that information related to the immediate surroundings of the customer may be provided to the customer. If the communication device is a mobile phone, PDA or other mobile device which uses location services, the report transmitted to the emergency service in step S320 may include a location of the communication device which is derived from the location services of the communication device.

The communication device 10 according to the present invention may be used as a supplement or a replacement of environment monitoring devices such as thermostats, fire control sensors, and desktop thermometers. A plurality of essentially stationary ones of the communication devices 10 may be arranged throughout a building or other area and used for mapping temperatures throughout the building or other area. Such maps may be used for verifying proper operation of HVAC systems.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A communication device, comprising:
a speaker;
a microphone disposed at a distance from said speaker; and
a processor connected to said speaker and said microphone and operatively arranged for determining ambient temperature by causing a test sound to be played on said speaker, measuring a transit time of the test sound from said speaker to said microphone, and calculating an ambient temperature of an environment in which the communication device is disposed from the measured transit time.

2. The communication device of claim 1, wherein said processor calculates the ambient temperature periodically.

3. The communication device of claim 1, further comprising an input device connected to said processor, wherein said processor determines the ambient temperature in response to a command input to said input device.

4. The communication device of claim 1, further including a memory connected to said processor for storing the distance from said speaker to said microphone.

5. The communication device of claim 1, wherein said processor includes means for deriving the distance from the speaker to the microphone at a reference temperature.

6. The communication device of claim 1, further comprising a display for visually conveying the calculated ambient temperature to a user of the communication device.

7. The communication device of claim 1, further comprising means for indicating to a user when the calculated ambient temperature exceeds a threshold temperature.

8. The communication device of claim 1, further comprising means for announcing a possible fire condition to a user of the communication device when the calculated ambient temperature exceeds a high threshold temperature.

9. The communication device of claim 8, further comprising means for requesting confirmation of the fire from the user of the communication device.

10. The communication device of claim 9, further comprising a transmitter for automatically sending a report to emergency services upon receipt of the confirmation of the fire by the user.

11. The communication device of claim 10, wherein said transmitter also sends a location of the communication device to the emergency services, the location derived from location services of said communication device.

12. The communication device of claim 1, further comprising a transmitter for automatically sending a report to emergency services when said processor determines an ambient temperature outside of an operating range.

13. The communication device of claim 12, wherein said transmitter also sends a location of the communication device to the emergency services, the location derived from location services of said communication device.

14. The communication device of claim 1, further comprising a transmitter for automatically sending a control signal to a heating/cooling system when said processor calculates an ambient temperature outside of an operating range.

15. The communication device of claim 1, further comprising an infrared sensor connected to said processor for detection of signals indicative of a fire, said processor initiating a determination of the ambient temperature in response to receiving a signal indicative of a fire from said infrared sensor.

16. The communication device of claim 1, wherein said communication device is a mobile phone.

17. The communication device of claim 1, wherein said communication device is operatively arranged for sending a signal indicating the determined ambient temperature to a second communication device during communication with the second communication device, said signal being sent automatically or in response to a user input.

18. The communication device of claim 1, further comprising a second microphone, wherein said processor measures a transit time of the test sound from said speaker to said second microphone and calculates the ambient temperature from the difference between transit times of the test sound to said microphone and to said second microphone.

19. A method for calculating ambient temperature of a communication device having a speaker and a microphone disposed from the speaker, comprising the steps of:
playing a test sound on the speaker;
measuring a transit time of the test sound from the speaker to the microphone; and
calculating an ambient temperature based on the measured transit time.

20. The method of claim 19, wherein said step of calculating comprises calculating the ambient temperature periodically.

21. The method of claim 19, wherein the communication device includes an input device and said step of calculating comprises calculating the ambient temperature in response to said input device.

22. The method of claim 19, wherein said means for calculating ambient temperature includes a memory and said method further comprises the step of storing a distance from the speaker to the microphone in said memory.

23. The method of claim 19, further comprising the step of deriving the distance from the speaker to the microphone at a reference temperature.

24. The method of claim 19, further comprising the step of displaying the determined ambient temperature on a display of the communication device.

25. The method of claim 19, further comprising the step of providing an indication to a user when the calculated ambient temperature exceeds a threshold temperature.

26. The method of claim 19, further comprising the step of announcing a possible fire condition to a user of the communication device when the calculated ambient temperature exceeds a high threshold temperature.

27. The method of claim 26, further comprising the step of requesting confirmation of the fire condition from the user of the communication device.

28. The method of claim 27, further comprising the step of automatically transmitting a report to emergency services upon receipt of the confirmation of the fire by the user.

29. The method of claim 28, further comprising the step of sending a location of the communication device to the emergency services, the location derived from location services of the communication device.

30. The method of claim 19, further comprising the step of automatically sending a report to emergency services when the calculated ambient temperature exceeds a high threshold.

31. The method of claim 30, further comprising the step of sending a location of the communication device to the emergency services, the location derived from location services of the communication device.

32. The method of claim 19, further comprising the step of automatically sending a control signal to a heating/cooling unit when the calculated ambient temperature is outside of an operating range.

33. The method of claim 19, wherein the communication device further comprises an infrared sensor and said method further comprises the step of using the infrared sensor for detecting a condition indicative of a fire.

34. The method of claim 19, wherein said method is performed on a plurality of communication devices located throughout a building or other area for mapping temperatures throughout the building or other area.

35. The method of claim 19, further comprising the step of automatically sending the determined ambient temperature to a second communication device upon initiation of communications with the second communication device.

36. The method of claim 19, further comprising the step of sending the determined ambient temperature to a second communication device in response to a user command.

37. The method of claim 19, wherein the communication device comprises a second microphone disposed from the speaker, said method further comprising the step of measuring a transit time of the test sound from the speaker to the second microphone, said step of calculating comprising calculating the ambient temperature from the difference between the transit times to the microphone and to the second microphone.

38. A communication device, comprising:
a speaker;
a first microphone disposed at a first distance from said speaker;
a second microphone disposed at a second distance from said speaker; and
a processor connected to said speaker and said first and second microphones and operatively arranged for determining ambient temperature by causing a test sound to be played on said speaker, measuring the time between reception of the test sound at said first microphone and reception of the test sound at said second microphone, and calculating an ambient temperature of an environment in which the communication device is disposed from the measured time.

39. A method for calculating ambient temperature of a communication device having a speaker, a first microphone disposed at a first distance from the speaker, and a second microphone disposed at a second distance from the speaker, comprising the steps of:
playing a test sound on the speaker;
measuring the time between reception of the test sound at the first microphone and reception of the test sound at the second microphone; and
calculating an ambient temperature based on the measured time.
